(19) United States
(12) Patent Application Publication
(10) Pub. No.: US 2018/0060948 A1
(43) Pub. Date: Mar. 1, 2018

(54) APPARATUS AND METHOD FOR PROVIDING A VIRTUAL SHOPPING ENVIRONMENT

(71) Applicant: Wal-Mart Stores, Inc., Bentonville, AR (US)

(72) Inventors: Todd D. Mattingly, Bentonville, AR (US); Nicholas Ray Antel, Springdale, AR (US); John J. O'Brien, Farmington, AR (US)

(21) Appl. No.: 15/685,554

(22) Filed: Aug. 24, 2017

Related U.S. Application Data
(60) Provisional application No. 62/379,136, filed on Aug. 24, 2016.

(51) Int. Cl. G06Q 30/06

(52) U.S. Cl. CPC G06Q 30/0643; G06Q 30/0639

(57) ABSTRACT

Systems, apparatuses, and methods are provided herein for providing a virtual shopping experience. A system for providing a virtual shopping experience comprises a virtual map database, an interaction rules database, a communication device, and a control circuit. The control circuit being configured to provide a virtual shopping space including representations of a plurality of items for sale to a user interface device associated with a customer, determine a store section corresponding to a location of the customer within the virtual shopping space based on the virtual map database, retrieve an interaction rule associated with the store section from the interaction rules database, wherein the interaction rule specifies supported interactions among a plurality of available interactions in the virtual shopping space, detect a customer movement in the store section, and modify the virtual shopping space based on the customer movement and the interaction rule associated with the store section.

### TECHNICAL FIELD

This application claims the benefit of the following U.S. Provisional Application No. 62/379,136 filed Aug. 24, 2016, which is incorporated herein by reference in its entirety.

### TECHNICAL FIELD

This invention relates generally to computer simulation.

### BACKGROUND

Traditional brick-and-mortar stores typically place items offered for sale out on the sales floors. In-store customers shop by selecting items off the shelves on the sales floor and bringing items to a checkout counter to make a purchase.

### BRIEF DESCRIPTION OF THE DRAWINGS

Disclosed herein are embodiments of apparatuses and methods for providing a virtual shopping experience. This description includes drawings, wherein:

FIG. 1 comprises a block diagram of a system as configured in accordance with some embodiments of these teachings;

FIG. 2 comprises a flow diagram of a method as configured in accordance with some embodiments of these teachings;

FIG. 3A comprises an illustration of virtual store as configured in accordance with some embodiments of these teachings;

FIG. 3B comprise an example of a set of interaction rules as configured in accordance with some embodiments of these teachings;

FIG. 4 comprises a flow diagram of a method as configured in accordance with some embodiments of these teachings;

FIG. 5 comprises a flow diagram of a method as configured in accordance with some embodiments of these teachings; and

FIGS. 6A, 6B, 6C, 6D, 6E, and 6F comprise rules tables in accordance with some embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for providing a virtual shopping experience. In some embodiments, a system for providing a virtual shopping experience comprises a virtual map database, an interaction rules database, a communication device, and a control circuit coupled to the virtual map database, the interaction rules database, and the communication device. The control circuit being configured to provide a virtual shopping space including representations of a plurality of items for sale to a user interface device associated with a customer via the communication device, determine a store section corresponding to a location of the customer within the virtual shopping space based on the virtual map database, retrieve an interaction rule associated with the store section from the interaction rules database, wherein the interaction rule specifies supported interactions among a plurality of available interactions in the virtual shopping space, detect a customer movement in the store section, and modify the virtual shopping space based on the customer movement and the interaction rule associated with the store section.

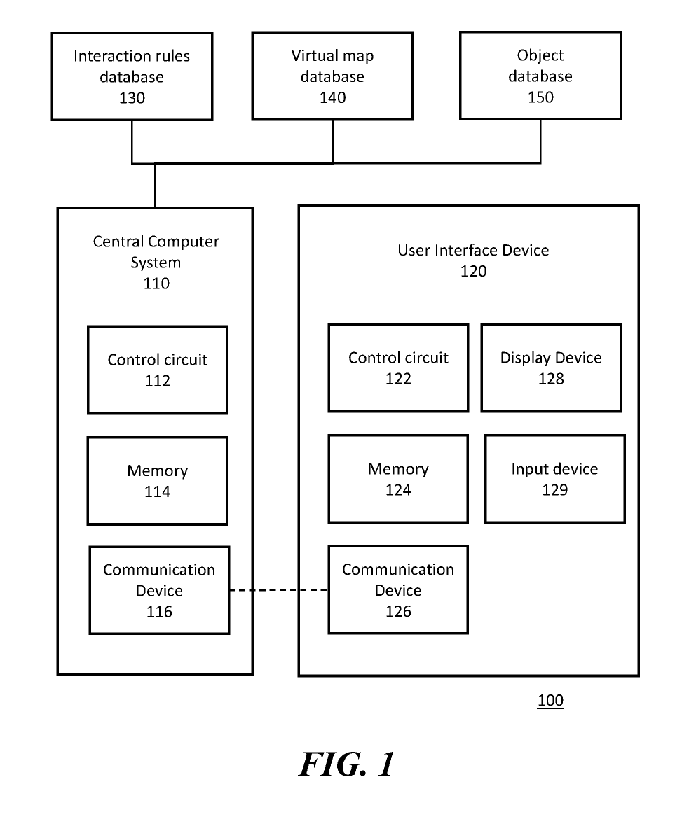

Referring now to FIG. 1, a system for providing a virtual shopping experience is shown. The system 100 includes a user interface device 120 and a central computer system 110 coupled to an interaction rules database 130, a virtual map database, and an object database 150.

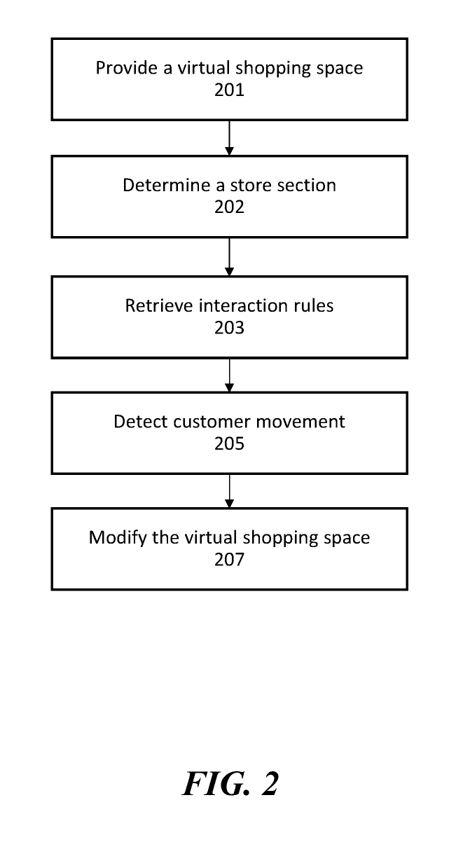

The central computer system 110 comprises a control circuit 112, a memory 114, and a communication device 116. The central computer system 110 may comprise one or more of a server, a central computing system, a virtual store system, and the like. The control circuit 112 may comprise a processor, a microprocessor, and the like and may be configured to execute computer readable instructions stored on a computer readable storage memory 114. The computer readable storage memory 114 may comprise volatile and/or non-volatile memory and have stored upon it, a set of computer readable instructions which, when executed by the control circuit 112, causes the central computer system 110 to provide a virtual shopping experience to the user interface device 120 via the communication device 116 based on information stored in one or more of the interaction rules database 130, the virtual map database 140, and the object database 150. The communication device 116 may comprise one or more of a network adapter, a data port, a router, a modem, and the like. Generally, the communication device 116 may be configured to allow the control circuit 112 to communicate with the user interface device 120 to provide a virtual shopping experience. In some embodiments, the virtual shopping experience may comprise a virtual reality graphical user interface (GUI) which customers can navigation around a virtual store and browse items displayed in the virtual store. In some embodiments, the virtual reality shopping space includes representations of a plurality of items offered for sale in a virtual reality environment. For example, the GUI may provide a simulation of a sales floor with aisles and shelves and/or display products in a simulated environment such as a farm, an orchard, and a sporting field. In some embodiments, the GUI may comprise a software program such as one or more of a computer program, a mobile application, and/or an interactive web content. In some embodiments, the computer executable instructions may cause the control circuit 112 of the central computer system 110 to perform one or more steps in the methods described with reference to FIG. 2 herein.

The virtual map database 140 may comprise computer readable memory configured to store one or more layouts of a virtual reality shopping space. In some embodiments, a virtual map layout may comprise locations of items within a section of a store and/or locations of sections relative to each other. For example, a virtual shopping space may simulate a traditional shopping space and have products arranged in aisles according to their categories. In some embodiments, the virtual map database 140 may store information relating the placement of sections within a virtual shopping space and/or placement of products within a section. In some embodiments, the layout of a virtual shopping space may be altered and/or customized based on various factors such as one or more of: customer preference, customer purchase history, customer demographic, promotions, seasonal offers, etc. In some embodiments, the layout of a virtual space may further include locations and other information for objects not offered for sale such as shelves, display modules, decorative elements, promotion elements, etc. In some embodiments, the layout of the virtual space may comprise one or more point clouds of the space and/or point clouds of individual items within the virtual space. In some embodiments, the layout map may be used to determine which sections of the virtual shopping space to present to the customer based the customer's movement and/or orientation in the virtual shopping space.

The interaction rules database 130 may comprise computer readable memory configured to store interaction rules associated with a plurality of sections of a virtual shopping space. In some embodiment, a section may correspond to an area, a group of aisles, an aisle, or a portion of an aisle in the virtual shopping space. In some embodiments, the interaction rules in the interaction rules database 130 may specify one or more actions that are enabled or disabled in one or more sections of the virtual shopping space. In some embodiments, the interaction rules may specific whether the store section supports one or more of a plurality of available interactions such as one or more of: hold, move, try-on, toss, carry around, bounce, push, and swing. In some embodiments, interaction rules may permit or prevent items in the store section from responding to customer movement with movements simulating real-world physics. For example, whether a virtual item will show to bounce and/or roll if the customer drops the item on the floor. In some embodiments, the interaction rules may permit or prevent items in the store section from being worn by a representation of the customer in the virtual shopping space. For example, an apparel item may be combined with an avatar of the customer to simulate the effect of the customer wearing the item. In some embodiments, interaction rules may permit or prevent items in the store section from being carried into other sections of the virtual shopping space. For example, decorative items may be carried around and placed next to other items for the customer to evaluate whether the items would look good together. In some embodiments, the interaction rule may permit or prevent items in the store section from interacting with other items in the virtual shopping space. For example, a customer may be permitted to hit a ball with a baseball bat in the sporting goods section to observe the interaction between the items. Generally, interaction rules may prevent or permit any type of customer interactions with items in the virtual shopping space. In some embodiments, the interaction rules database 130 may further store navigation rules associated with the store section. For example, the navigation rules may specify which areas in the store section a customer may enter.

The object database 150 may comprise computer readable memory configured to store parameters for a plurality of objects. The objects in the object database may correspond to items offered for sale in the virtual shopping space. In some embodiments, the object database may further store parameters associated with decorative and/or informational items in the virtual shopping space. In some embodiments, the object parameters may comprise parameters for simulating movements and/or appearances of items in the virtual shopping space. In some embodiments, the object parameters may comprise one or more of: weight, weight distribution, density, elasticity, resilience, pliability, tortuousness, bounciness, fluidity, etc. for the object and/or one or more parts of the object. In some embodiments, the object parameters may comprise physical property parameters configured to be used by a physics simulation engine to simulate the physical properties of the object in a virtual reality environment. In some embodiments, object parameters for each item stored in the objects database may correspond to interactions supported under the interaction rules associated with store sections of the virtual store in which each item is displayed. For example, for an object in a section of the virtual in where the throwing of items is not supported, the object parameters of objects display in the section may not include properties such as weight and bounciness.

The user interface device 120 comprises a processor-based device configured to provide a virtual reality shopping environment. The user interface device 120 comprises a control circuit 112, a memory 124, a communication device 126, a display device 128, and an input device 129. In some embodiments, the user interface device 120 may be configured to provide a graphical user interface configured to provide a virtual reality shopping experience to a user. In some embodiments, the user interface device 120 may comprise one or more of a virtual reality display, an augmented reality display, a head mounted display device, a virtual reality booth, a computer system, a projection display device, a holographic display device, etc.

The user interface device 120 comprises a control circuit 122, a memory 124, a communication device 116, a display device 128, and an input device 129. The control circuit 122 may comprise a processor, a microprocessor, and the like and may be configured to execute computer readable instructions stored on a computer readable storage memory 124. The computer readable storage memory 124 may comprise volatile and/or non-volatile memory and have stored upon it, a set of computer readable instructions which, when executed by the control circuit 122, causes the user interface device 120 to provide a virtual shopping experience via the display device 128 and the input device 129 based on communications with the central computer system 110 via the communication device. In some embodiments, the computer executable instructions may cause the control circuit 122 of the user interface device 120 to perform one or more steps in the methods described with reference to FIG. 2 herein.

In some embodiments, the memory 124 may have stored on it, a software program such as one or more of a computer program, a mobile application, a cloud-based application, etc. that is configured to provide the virtual shopping experience GUI to the user based on a communication with the central computer system 110. The communication device 126 may comprise one or more of a network adapter, a data port, a router, a Wi-Fi transceiver, a mobile data network transceiver, etc. The display device 128 may comprise one or more of a flat screen display, a projection display device, a virtual reality display device, an augmented reality display device, and the like. The display device 128 may generally be configured to display the GUI to a viewer. The input device 129 may comprise one or more of an optical sensor, a camera, a motion tracker, an eye tracker, a gesture tracker, buttons, a controller, a microphone, and the like. In some embodiments, the input device 129 may comprise a customer movement sensor configured to detect movements of the customer's body. Generally, the input device 129 may be configured to detect one or more types of inputs from a user.

In some embodiments, one or more of the display device 128, the input device 129, and the communication device 126 may comprise a separately implemented device. For example, the control circuit 122 and the memory 124 may comprise a computer unit such as a desktop computer, a mobile device, etc., and the display device 128 may comprise a head mounted display and the input device 129 may comprise separately situated sensors in communication with the control circuit 122.

While one user interface device 120 is shown in FIG. 1, in some embodiments, the central computer system 110 may be configured to simultaneously provide virtual shopping experiences to a plurality of user interface devices based on the information stored in one or more of the interaction rules database 130, the virtual map database 140, and the object database 150. In some embodiments, the central computer system 110 and the user interface device 120 may be implemented on the same physical device. For example, the central computer system 110 and the user interface device 120 may share the same control circuit and/or memory. The communication device 116 of the central computer system 110 may be configured to communication with the display device 128 and/or the input device 129 via a local or a networked data connection. In some embodiments, one or more of the interaction rules database 130, the virtual map database 140, and the object database 150 may be implemented the same one or more computer readable memory devices. In some embodiments, one or more of the interaction rules database 130, the virtual map database 140, and the object database 150 may be implemented on one or more of the memory 114 of the central computer system 110 and the memory 124 of the user interface device 120.

Referring now to FIG. 2, a method for providing a virtual shopping experience is shown. In some embodiments, the steps shown in FIG. 2 may be performed by a processor-based device such as a control circuit executing a set of computer readable instructions stored on a computer readable memory. In some embodiments, one or more steps of FIG. 2 may be performed by one or more of the control circuit 112 of the central computer system 110 and/or the control circuit 122 of the user interface device 120 described with reference to FIG. 1 herein.

In step 201, the system provides a virtual shopping space to a customer. In some embodiments, the virtual shopping space includes representations of a plurality of items for sale. In some embodiments, the virtual shopping space may be provided through a user interface device associated with the customer. In some embodiments, the user interface device may comprise one or more of a virtual reality display, an augmented reality display, a head mounted display device, a virtual reality booth, a computer system, a projection display device, a holographic display device, etc. The virtual shopping space may comprise a graphical user interface (GUI) displayed via the user interface device. In some embodiments, the GUI may comprise a virtual reality or augmented reality environment in which customers can navigate a virtual store and browse items displayed in the virtual store. In some embodiments, the system may further track user's location within the virtual shopping space based on user input such as user movement, user voice command, user eye or head movement, etc. detected by one or more user input devices coupled to the user interface device.

In step 202, the system determines a store section corresponding to a location of the customer within the virtual shopping space. In some embodiments, the virtual shopping space may comprise a plurality of sections each displaying items for sale. In some embodiments, the virtual shopping space may further comprise non-display areas such as dressing room or other simulated environments such as a sporting field, a beach, a kitchen, etc. In some embodiments, sections of the virtual shopping space may correspond to different categories of items offered for sale, similar to store sections of a traditional brick and mortar store. In some embodiments, a section may correspond to an area, a group of aisles, an aisle, a portion of an aisle in the virtual shopping space, etc. In some embodiments, a section of a virtual shopping space may correspond to any portion of the virtual shopping space. In some embodiments, the store section corresponding to the location of the customer may be determined based on a virtual map database recording locations of store sections relative to each other. In some embodiments, the system may determine a coordinate of the customer within the virtual shopping space and determine the store section that encompasses the determined coordinate. In some embodiments, layouts of store sections in the virtual map database may be customized to for one or more customers.

In step 203, the system retrieves interaction rule associated with the store section identified in step 202. In some embodiments, the interaction rule may be retrieved from an interaction rules database. In some embodiments, the interaction rule specifies one or more supported interactions among a plurality of available interactions in the virtual shopping space. In some embodiments, the interaction rules may comprise one or more actions that are enabled or disabled in one or more sections of the virtual shopping space. In some embodiments, the interaction rules may specific whether a section supports the plurality of available interactions comprising one or more of: hold, move, try-on, toss, carry around, bounce, push, and swing. In some embodiments, interaction rules may permit or prevent items in a store section from responding to customer movement with movements simulating real-world physics. In some embodiments, the interaction rules may permit or prevent items in a store section from being worn by a representation of the customer in the virtual shopping space. In some embodiments, interaction rules may permit or prevent items in a store section from being carried into other sections of the virtual shopping space. In some embodiments, the interaction rules may permit or prevent items in a store section from interacting with other items in the virtual shopping space. In some embodiments, the interaction rules may be retrieved just prior to the section is rendered and/or loaded for display to a customer. In some embodiments, the interaction rules may be retrieved when the customer begins to interact with one or more items in the store section.

In step 205, the system detects a customer movement. In some embodiment, the customer movement may correspond to a real-world action of the customer. For example, the customer may motion to pick an item off the shelf, hold the item whole walking around, throw an item, swing an item, etc. In some embodiments, the movement may be determined based on a customer movement sensor that tracks the customer's motions in the virtual shopping space. In some embodiments, customer movement may comprise movements of one or more parts of the customer's body such as arm, hand, finger, leg, head, eye, etc. In some embodiments, a customer movement may correspond to a voice command (e.g. “try this on,” “turn around,” etc.) In some embodiments, the system may further determine at least one item associated with the movement detected in step 205. For example, the system may determine an item that the user intends to interaction within the virtual environment based on the location of the customer, the orientation of the customer, the arm position of the user, the arm motion of the user, etc. In some embodiments, the system may further determine one or more of the force, the momentum, the direction, the angle, the height, etc. of the movement in step 205. In some embodiments, the system may determine an interaction associated with the movement such as one or more of hold, move, try-on, toss, carry around, bounce, push, and swing. In some embodiments, the interaction type may be determined based on comparing the detected motion with a plurality interaction type profiles that describes parameters for each interaction types. The interaction type profile may be based on one or more of a customer's location, customer's posture, customer's arm movement, customer's leg movement, the speed of the movement, etc.

In step 207, the system modifies the virtual shopping space in response to the customer movement detected in step 205. In some embodiments, the modification of the virtual shopping space is based on the detected movement and the interaction rule of the section retrieved in step 204. In some embodiments, the system may determine how one or more items in the section should respond to the customer's movement based on the interaction rules. For example, if the throwing of an item is not permitted in a section of the virtual store, and a customer attempts to throw an item, the item may remain in the customer's hand and/or return to the shelf. On the other hand, if the throwing of the item is permitted and the section enables the simulation of real-world physics, a physics simulation engine may be engaged and the virtual item may be shown to travel through the air and/or bounce off one or more surfaces based on the object's properties. In another example, if carrying an object around is enabled in a section, the system may add a representation of the item onto an avatar of the customer in the virtual environment as the customer continues to navigate through the virtual store. In yet another example, if a section enables items to be tried on, the item (e.g. apparel, jewelry, etc.) may be combined with the avatar of the customer at a designated location (e.g. torso, head, feet, etc.) to simulate the avatar wearing the item. In some embodiments, the representation of the item on an avatar may further be modified based on the dimensions associated with the customer and/or the avatar (e.g. height, waistline, shoulder width, etc.). In sections in which try-on is disabled, the item may remain in on the shelf or in the customer's hand without being modified based on parameters associated with the customer and/or the avatar.

In some embodiments, the system may include different algorithm and/or parameters for providing different sections of the virtual store based on the interaction rules. For example, a physics simulation engine may not be engaged for rendering store sections that do not enable real-world physics simulations. In another example, if picking up of items is not permitted, the system may only render the customer-facing side of the item for display instead of generating a full three-dimensional virtual object in the virtual shopping space. In some embodiments, the system may comprise an object database storing object parameters for simulating movements of items in the virtual shopping space. The object parameters for each item stored in the objects database may correspond to interactions supported under the interaction rules associated with store sections of the virtual store in which each item is displayed. In some embodiments, the object parameters may comprise one or more of: weight, weight distribution, density, elasticity, resilience, pliability, tortuousness, bounciness, fluidity, etc. for the object and/or one or more parts of the object. In some embodiments, the object parameters may comprise physical property parameters that can be used by a physics simulation engine to emulate the physical properties of the object in a virtual reality environment.

In some embodiments, steps 202-207 may be repeated as a customer navigates around a virtual shopping space. In some embodiments, steps 202 and 203 may be performed when a customer moves from one store section to another. In some embodiments, steps 205 and 207 may be repeated as the customer perform different actions in a store section.

In some embodiments, in additional to the interaction rules for the section, one or more objects may also include object specific interaction rules that further restricts interactions for items within the section. For example, a section interaction rule may permit simulation of real-world physics for the section and object-specific interaction rules may allow some objects to be thrown while preventing other objects to be thrown.

With the process shown in FIG. 2, the system may selectively disable and/or enable available interactions in sections of the virtual shopping space to reduce the computational demands and/or bandwidth requirements for providing an immersive virtual shopping experience. With systems and methods described herein, sections of the store that do not require all available interactions may be loaded and rendered on the user interface device more efficiently by reducing the algorithms and parameters used. In some embodiments, the system may still provide relevant interactions in select sections of the virtual store for customer experience while providing seamless navigation between sections of the store with different interaction rules.

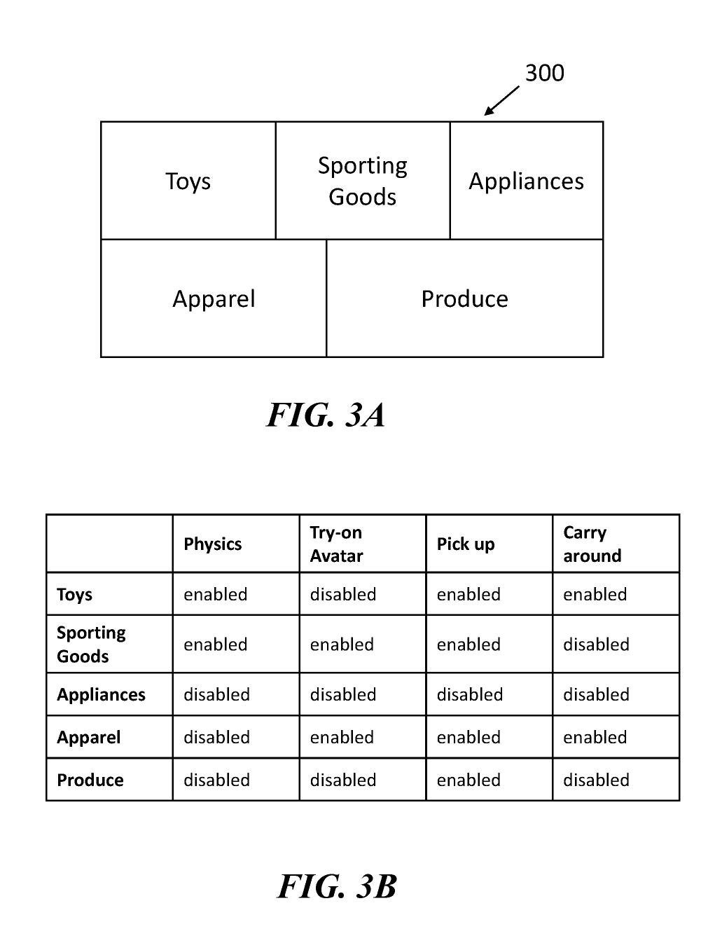

Referring now to FIGS. 3A and 3B, an illustration of sections of a virtual store and a set of corresponding interaction rules are shown. The virtual store 300 shown in FIG. 3A includes a toys section, a sporting goods section, an appliances section, an apparel section, and a produce section. In some embodiments, the layout of the virtual store 300 may be stored in a virtual map database. The system may track the location of the user and determine which store section corresponds to the user's location in the virtual store. In some embodiments, the system may detect when a customer moves from one of the sections to another and load the interaction rules associated with the new section in response. In some embodiments, a customer in one section may see a representation of another section before navigating into the other section. In some embodiments, the representation of the sections may be presented as seamless to the customer as the customer navigates around, however, the system may load different interaction rules in the background when the user leaves one section and enters another. In some embodiments, sections that the customer is not currently in may be rendered for display only with all interactions disabled. For example, when the customer leavings the sporting goods section and enter the produce section, the customer may turn around and still see the sporting goods sections, but the physics simulation engine may be turned off for all items. The layout shown in FIG. 3A is provided as an example only. A virtual shopping space may comprise any type and any number of sections in any arrangement without departing from the spirits of the present disclosure.

FIG. 3B shows an example set of interaction rules. The sections shown includes toys, sporting goods, appliances, apparel, and produce. For each section, “physics,” “try-on avatar,” “pick up,” and “carry around” are either enabled or disabled. “Physics” may refer to the simulation of real-world physics such as items falling, bouncing, rolling, etc. In some embodiments, for each section that the simulation of real-world physics is turned on, the system may engage a physics engine to provide the virtual shopping experience in that section. In some embodiments, one or more item displayed in sections that are configured to simulate real-world physics may have associated with it, one or more object parameters corresponding to the item's physical properties such as weight distribution. “Try-on avatar” may refer to simulating a customer's avatar wearing the selected item (e.g. clothing, jewelry, footwear, etc.). In some embodiments, for each section that the try-on function is enabled, the system may engage an avatar rendering engine that can modify the appearance of the customer's avatar in the store section based on the selected items. In some embodiments, one or more item displayed in sections that allow try-ons may have associated with it, one or more object parameters corresponding to the item's measurement such as inseam, arm length, hem length, and/or the item's physical properties such as elasticity, bendiness, etc. “Pick-up” may refer to whether an item in the section may be moved from the display location by the customer. In some embodiments, when pick-up is disabled, the system may only render the customer facing side of items displayed in the section of the virtual shopping space. “Carry around” may refer to whether an item may be carried by the customer in the current section and/or to different sections of the virtual store. In some embodiments, when “carry around” is enabled, interactions between items may also be enabled. In some embodiments, when an item is carried from one section to another, the interaction rules of the new section may be applied to the item. In some embodiments, when an item is carried from one section to another, the interaction rules originally associated with the item may also be carried into the new section.

The set of interaction rules shown in FIG. 3B is provided as an example only. Interaction rules for sections of a virtual shopping space may be variously configured and include various interaction types without departing from the spirit of the present disclosure.

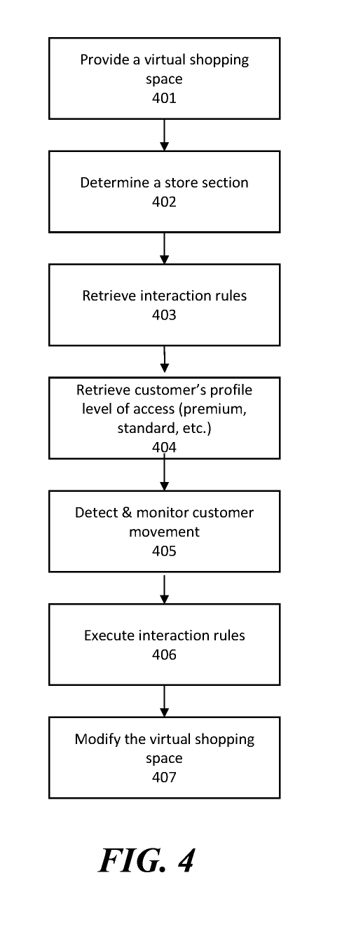

Referring now to FIG. 4, a method for providing a virtual shopping space is shown. In step 401, a virtual shopping space is provided by a computer system. In step 402, the system determines the store section associated with the user's location. In step 403, the system retrieves the interaction rules of the section. In step 404, the system retrieves the customer's profile level of access. In some embodiments, the user may be assigned as a premium user, a standard user, a basic user, etc. In step 405, the system detects and monitor the user's movement in the virtual shopping space. In step 406, the system executes interaction rules according to the user's virtual location and/or the user's profile level. In step 407, the system modifies the rendering of the virtual shopping space in response to the user's actions in accordance to the interaction rules.

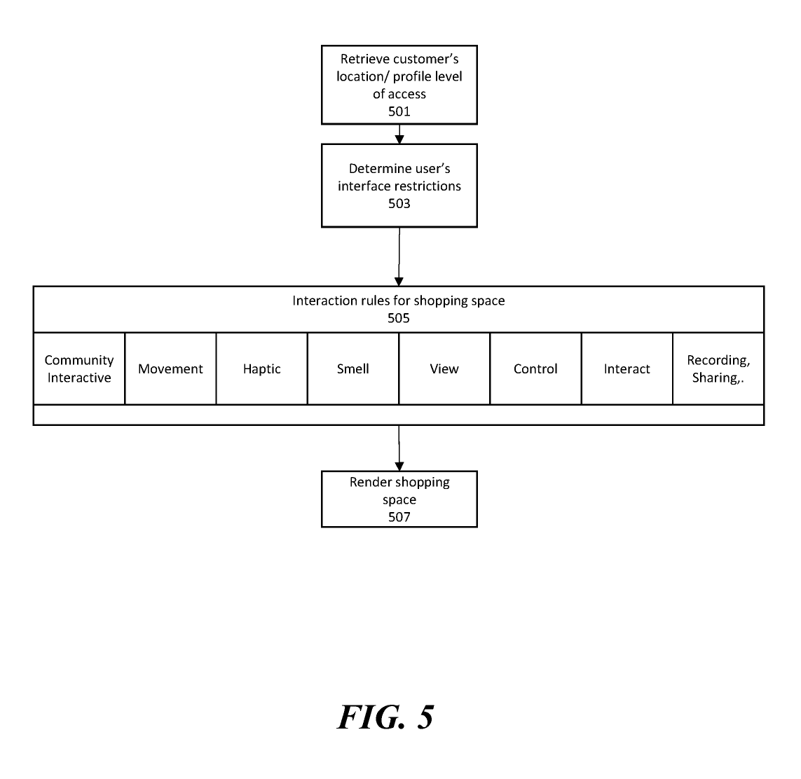

Referring now to FIG. 5, a method for providing a virtual shopping space is shown. In step 501, the system retrieves the customer's location and/or profile level of access. In step 503, the system determines the user's interaction restrictions. In step 505, the interaction rules for shopping space are executed by various rendering engines of the system. In some embodiments, interaction rules may comprise rules for community interactions, movement, haptic feedback, smell feedback, viewig, interface control, item interaction, and recording sharing. In step 507, the system renders the shopping space according to the interaction rules.

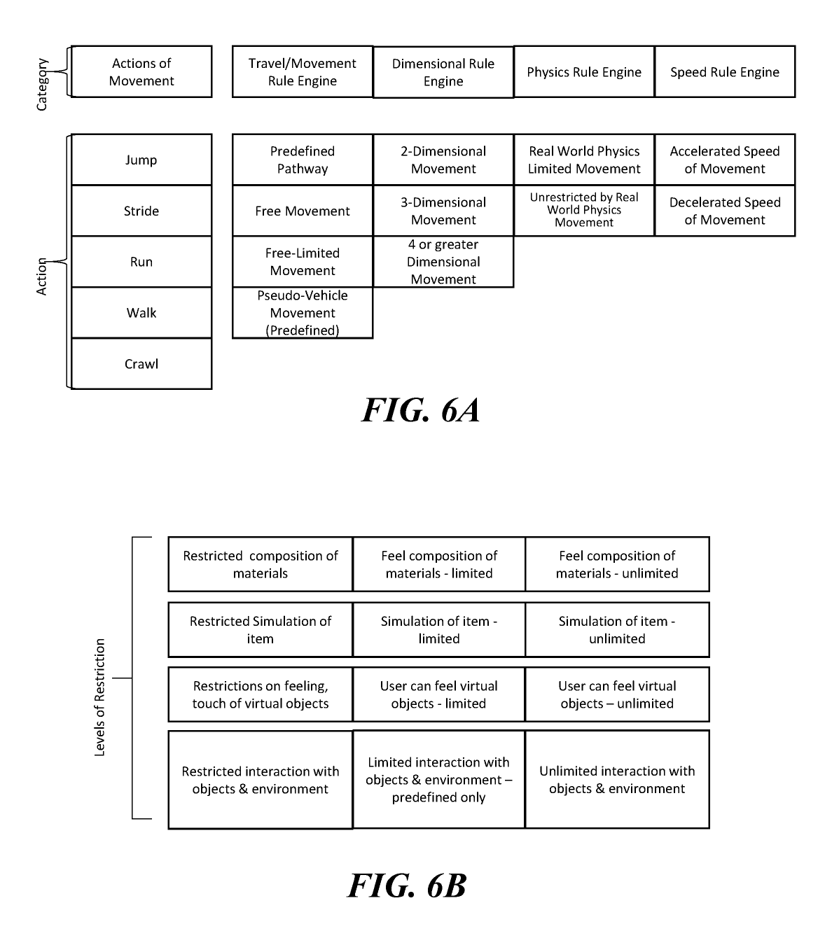

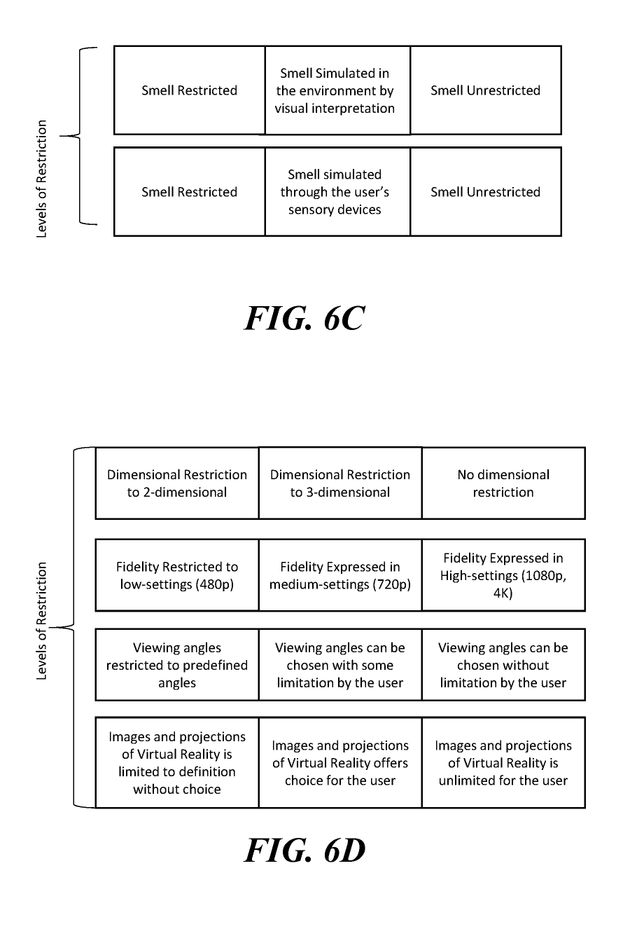

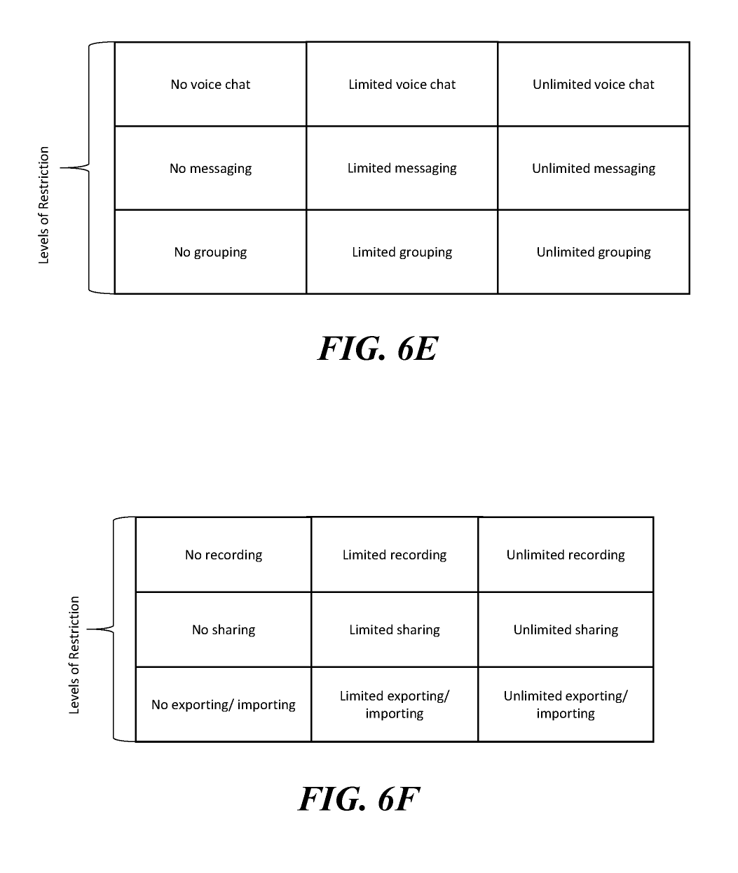

Referring now to FIGS. 6A-F, examples of interaction rules table are provided. FIG. 6A comprises an example set of movement rules. In some embodiments, the system permit one or more types of movement in a virtual shopping space such as jump, stride, run, walk, and crawl. Based on the allowed movement type, the system may select from at least one rules from to execute in each of the travel/movement rule engine, the dimensional rule engine, a physics rule engine, and a speed rule engine. In FIG. 6A, the travel/movement rule may allow for movement in a predefined pathway, free movement, freedom-limited movement, or pseudo-vehicle movement. The dimensional rule engine may allow for 2-dimensional movement, 3-dimensional movement, or 4 or great dimensional movement. The physics rule engine allows for real world physics limited movement or unrestricted by real world physics movement. The speed rule engine may allow for accelerated speed of movement or decelerated speed of movement. For example, interaction rules restricts the movement in an area to walk-only, the travel/movement engine may allow for move along a predefined pathway, the dimension rule engine may allow for two dimensional movement, the physics rule engine may simulate real world physic limited movement, and the speed rule engine may provide normal or decelerated speed of movement. In some embodiments, the rules executed by each engine may be individually associated with different sections of a virtual store and/or user profiles.

FIG. 6B comprises a rules table for touch/haptic rules according to some embodiments. A haptic engine of the virtual shopping space system may execute one or more rules associated with feeling the composition materials, simulation of items, feeling the virtual object, and interactions with objects and environments. The engine may restrict feeling the composition of materials, limit feeling the composition of materials, and provided unlimited haptic feeling feedback of composition of materials. The engine may provide restricted simulation, limited simulation of items, or unlimited simulation of items. The engine may provide restricted touching of virtual objection, limited touching of virtual objects, and unlimited touching of virtual objects. The engine may further provide restriction interaction with objects and environment, limited predefined interaction with objects and environment, and unlimited interaction with objects and environment. In some embodiments, the touch rules may be individually associated with different sections of a virtual store and/or user profiles.

FIG. 6C comprises a rules table for olfactory simulation according to some embodiments. A smell engine of the virtual shopping space system may execute one or more rules smell simulation. The smell engine may restrict smell simulation, simulate smells through visual interpretation, simulate smell through a user-end sensory device, or provided unrestricted smell simulation. In some embodiments, the smell rules may be individually associated with different sections of a virtual store and/or user profiles.

FIG. 6D shows a rules table for view rendering according to some embodiments. A view engine of the virtual shopping space system may execute one or more rules associated rendered dimensions, image fidelity, viewing angles, and image and projection offering. The view engine may restrict views to 2D, 3D, or impose no dimensional restriction. The view engine may restriction fidelity to low (e.g. 480p), medium (e.g. 720p), or high (e.g. 1080p, 4 k, etc.). The view engine may restrict viewing angles to a predefined range or user selected range, or impose not viewing angle restrictions. In some embodiments, the system may control whether users can view in different perspectives, such as first person, second person, third person, etc. Further, the angles and points of view may have different degrees of choice and selection for the user. The view engine may offer a selected set of images and projections in the VR environment, allow users to choose from image projections in the VR environment, or impose no restrictions on the images and projections in the VR environment. In some embodiments, the Virtual Reality environment may include the capability which allow the user to customize to the images and projection in Virtual Reality, such as wireframe viewing, 3-dimensional or 2-d viewing, color changes, perspective changes (e.g. first person or third person). In some embodiments, the viewing rules may be individually associated with different sections of a virtual store and/or user profiles.

FIG. 6E shows a rules table for community interactions according to some embodiments. A social engine of the virtual shopping space system may execute one or more rules associated with voice chat, messing, and forming groups. The social engine may allow no voice chat, limited voice chat (e.g. age restricted, vocabulary restriction, location restricted), or unlimited voice chat. The social engine may allow no messaging, limited messaging, or unlimited messaging. The social may allow for no grouping of users, limited grouping of users, and unlimited grouping of users. In some embodiments, the community interaction rules may be individually associated with different sections of a virtual store and/or user profiles.

FIG. 6F shows a rules table for recording and sharing according to some embodiments. A sharing engine of a virtual shopping space system may execute one or more rules associated with recording, sharing, and exporting/importing of images and virtual objects in the virtual shopping space. The sharing engine may allow no recording, allow limited recording, or impose no recording restrictions. The sharing engine may allow for no sharing, limited sharing, or impose no sharing restrictions. The sharing engine may allow for no exporting/importing of content, allow limited exporting/importing of content, or impose not restrictions on exporting/importing of content. In some embodiments, the sharing rules may be individually associated with different sections of a virtual store and/or user profiles.

One concern of providing virtual reality malls and stores is the system resources required to produce the experience that is immersive yet stable. In some embodiments, the systems and methods described herein seek to optimize the usage of systems resources required to produce virtual reality malls and stores by selectively providing navigation options to users through the use of defined navigational zones. In some embodiment, the customer may be limited in where they can travel within the store. In some embodiments, in certain zones or shopping areas, specific movements may be allowed or limited. For example, in an apparel section, a customer may be restricted to only trying on apparel without being able to navigate throughout the apparel section; whereas, in a sporting goods sections a customer may be allowed to interact with a product and take this product onto the field for testing.

In some embodiments, a virtual shopping experience is provided based on predefined paths with limited or controlled movement for the management of systems resources. In some embodiments, the limitations may be determined based on store zones, point clouds, etc. In some embodiments, a point cloud model of a shopping space may be accurate to within the store's structure. In some embodiments, a shopping space may be separated into zones having specific areas with allowed movements.

In some embodiments, the system allows the customer to view the entirety of the store without having to deploy system resources for supporting the same degree of navigation and/or interaction throughout the entire store. In some embodiments, specific movements may be allotted for specific zones. For example, in a sporting good section, a customer may be permitted to interact with products in ways that are not permitted in the produce section. In some embodiments, in a clothing section, a customer can view and see the product on their avatar, allowing for fitting feedback. In some embodiments, in a sporting goods section, a customer can interact with products in a simulated environment where the product could be used in the real worlds. In some embodiments, customer's movements within the virtual shopping space may be detected via one or more of: audio inputs, gesture controls, movement capturing devices (e.g. optical sensors, range sensors, mechanical motion sensors, etc.), and movement mimicking devices (e.g. virtual reality motion platform, etc.).

In one embodiment, a system for providing a virtual shopping experience comprises a virtual map database, an interaction rules database, a communication device, and a control circuit coupled to the virtual map database, the interaction rules database, and the communication device. The control circuit being configured to provide a virtual shopping space including representations of a plurality of items for sale to a user interface device associated with a customer via the communication device, determine a store section corresponding to a location of the customer within the virtual shopping space based on the virtual map database, retrieve an interaction rule associated with the store section from the interaction rules database, wherein the interaction rule specifies supported interactions among a plurality of available interactions in the virtual shopping space, detect a customer movement in the store section, and modify the virtual shopping space based on the customer movement and the interaction rule associated with the store section.

In one embodiment, a method for providing a virtual shopping experience comprises providing, with a control circuit, a virtual shopping space including representations of a plurality of items for sale to a user interface device associated with a customer via the communication device, determining a store section corresponding to a location of the customer within the virtual shopping space based on the virtual map database, retrieving, with a control circuit, an interaction rule associated with the store section from an interaction rules database, wherein the interaction rule specifies supported interactions among a plurality of available interactions in the virtual shopping space, detecting a customer movement in the store section, and modifying, with the control circuit, the virtual shopping space based on the customer movement and the interaction rule associated with the store section.

In one embodiment, an apparatus for providing a virtual shopping experience comprises a non-transitory storage medium storing a set of computer readable instructions; and a control circuit configured to execute the set of computer readable instructions which causes to the control circuit to: provide, with a control circuit, a virtual shopping space including representations of a plurality of items for sale to a user interface device associated with a customer via the communication device, determine a store section corresponding to a location of the customer within the virtual shopping space based on a virtual map database, retrieve, with a control circuit, an interaction rule associated with the store section from an interaction rules database, wherein the interaction rule specifies supported interactions among a plurality of available interactions in the virtual shopping space, detect a customer movement in the store section, and modify, with the control circuit, the virtual shopping space based on the customer movement and the interaction rule associated with the store section.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for reducing computing resource demand of providing a virtual shopping experience comprising:
a virtual map database;
an interaction rules database;
a communication device; and
a control circuit coupled to the virtual map database, the interaction rules database, and the communication device, the control circuit being configured to:
provide a virtual shopping space including representations of a plurality of items for sale to a user interface device associated with a customer via the communication device;
determine a store section corresponding to a location of the customer within the virtual shopping space based on the virtual map database;
retrieve an interaction rule associated with the store section from the interaction rules database, wherein the interaction rule specifies supported interactions among a plurality of available interactions in the virtual shopping space;
detect a customer movement in the store section; and
modify the virtual shopping space based on the customer movement and the interaction rule associated with the store section.

2. The system of claim 1, wherein one or more of the location of the customer and the customer movement is detected via a customer movement sensor coupled to the communication device.

3. The system of claim 1, wherein the virtual shopping space is displayed via a virtual reality display device coupled to the communication device.

4. The system of claim 1, wherein the plurality of available interactions comprises one or more of: hold, move, try-on, toss, carry around, bounce, push, and swing.

5. The system of claim 1, wherein the interaction rule permits or prevents items in the store section from responding to the customer movement with movements simulating real-world physics.

6. The system of claim 1, wherein the interaction rule permits or prevents items in the store section from being worn by a representation of the customer in the virtual shopping space.

7. The system of claim 1, wherein the interaction rule permits or prevents items in the store section from being carried into other sections of the virtual shopping space.

8. The system of claim 1, wherein the interaction rule permits or prevents items in the store section from interacting with other items in the virtual shopping space.

9. The system of claim 1, further comprising an object database storing object parameters for simulating movements of items in the virtual shopping space.

10. The system of claim 9, where object parameters for each item correspond to interactions supported under the interaction rule associated with the store section of the virtual shopping space in which each item is displayed.

11. A method for reducing computing resource demand of providing a virtual shopping experience comprising:
providing, with a control circuit, a virtual shopping space including representations of a plurality of items for sale to a user interface device associated with a customer via a communication device;
determining a store section corresponding to a location of the customer within the virtual shopping space based on a virtual map database;
retrieving, with the control circuit, an interaction rule associated with the store section from an interaction rules database, wherein the interaction rule specifies supported interactions among a plurality of available interactions in the virtual shopping space;
detecting a customer movement in the store section; and
modifying, with the control circuit, the virtual shopping space based on the customer movement and the interaction rule associated with the store section.

12. The method of claim 11, wherein one or more of the location of the customer and the customer movement is detected via a customer movement sensor coupled to the communication device.

13. The method of claim 11, wherein the virtual shopping space is displayed via a virtual reality display device coupled to the communication device.

14. The method of claim 11, wherein the plurality of available interactions comprises one or more of: hold, move, try-on, toss, carry around, bounce, push, and swing.

15. The method of claim 11, wherein the interaction rule permits or prevents items in the store section from responding to the customer movement with movements simulating real-world physics.

16. The method of claim 11, wherein the interaction rule permits or prevents items in the store section from being worn by a representation of the customer in the virtual shopping space.

17. The method of claim 11, wherein the interaction rule permits or prevents items in the store section from being carried into other sections of the virtual shopping space.

18. The method of claim 11, wherein the interaction rule permits or prevents items in the store section from interacting with other items in the virtual shopping space.

19. The method of claim 11, wherein the virtual shopping space is modified based on an object database storing object parameters for simulating movements of items in the virtual shopping space.

20. The method of claim 19, where object parameters for each item correspond to interactions supported under the interaction rule associated with the store section of the virtual shopping space in which each item is displayed.

21. An apparatus for reducing computing resource demand of a virtual shopping experience comprising:
a non-transitory storage medium storing a set of computer readable instructions; and
a control circuit configured to execute the set of computer readable instructions which causes to the control circuit to:
provide a virtual shopping space including representations of a plurality of items for sale to a user interface device associated with a customer via a communication device;
determine a store section corresponding to a location of the customer within the virtual shopping space based on a virtual map database;
retrieve an interaction rule associated with the store section from an interaction rules database, wherein the interaction rule specifies supported interactions among a plurality of available interactions in the virtual shopping space;
detect a customer movement in the store section; and
modify the virtual shopping space based on the customer movement and the interaction rule associated with the store section.
